(19) United States
(12) Patent Application Publication
(10) Pub. No.: US 2009/0157568 A1
(43) Pub. Date: Jun. 18, 2009

(54) Flatware marketing method

(76) Inventor: Donald J. Ladanyi, West Lake, OH (US)

Correspondence Address: BROUSE MCDOWELL LPA, 388 SOUTH MAIN STREET, SUITE 500, AKRON, OH, 44311, US

(21) Appl. No.: 11/527,346

(22) Filed: Sep. 25, 2006

(51) Int. Cl. G06Q 90/00

(52) U.S. Cl. 705/500

(57) ABSTRACT

A method for advertising an eating utensil by using or describing a flavorless taste characteristic of the utensil. Related advertising embodiments are provided.

### BACKGROUND OF THE INVENTION

The need for advertising is well established in the business setting, and it is not uncommon for businesses entities to devote significant resources to advertising their goods, services, trademarks, and overall goodwill. Effective advertising can have a significant impact on the profits realized by a business entity, and there is therefore a need for business entities to use effective marketing methods.

Flatware (e.g., forks, knives, and spoons) and flatware sets are commonly advertised in magazines by using pictures of the flatware in combination with the associated retail cost. Retail catalogs commonly provide these kinds of flatware advertisements, and using this advertising method to sell flatware as well as other merchandise is well established.

There remains a need in the art for additional advertising methods directed to selling flatware and flatware sets.

### SUMMARY OF THE INVENTION

Generally provided is a method for advertising an eating utensil comprising: advertising an eating utensil using a flavorless taste characteristic of the utensil.

Generally provided is a method for advertising an eating utensil comprising: advertising an eating utensil by using language that generally describes a flavorless taste characteristic of the utensil in the advertisement.

Generally provided is a method for advertising an eating utensil comprising: advertising an eating utensil by describing a food-contact surface of the utensil as being chemically inert when contacted with an edible substance.

Generally provided is a method for advertising an eating utensil comprising: advertising an eating utensil by advertising that a food-contact surface of the utensil prevents electrical, chemical, or both electrical and chemical activity from occurring between the utensil and a user's mouth, tongue, lips, taste buds, or a combination thereof.

The marketing method provided herein is directed to targeting the general public's interest in organically pure food products. More specifically, the subject marketing method provides a business advantage by targeting the public's interest in food-related products that can be generally described as organically inert, organically friendly, organically pure, organically produced, or a combination thereof. Marketing an eating utensil by the subject method provides a business advantage over known prior-art marketing methods for utensils.

### DETAILED DESCRIPTION OF THE INVENTION

Generally provided is a marketing or advertising method directed to selling eating utensils, wherein the advertising method is based upon the eating utensil's alleged ability to preserve and not altar the taste of an edible substance that contacts the eating utensil. Stated differently, the method is based upon an eating utensil's flavorless taste characteristic that can be described in one embodiment as preventing additional chemical substances or electrical activity from being added to an edible substance that contacts or has contacted the utensil. In an embodiment, a flavorless taste characteristic of an eating utensil can be understood as the ability of the eating utensil to prevent altering, adding, or detracting to the taste of an edible substance that has contacted or contacts an edible substance.

Any eating utensil can be the subject of the marketing method, and non-limiting examples include forks, knives, and spoons. A non-limiting list of utensil embodiments includes: serving fork, spoon, and knife; large, banquet-style, serving fork, spoon, and knife; two-prong meat fork; spatula; pastry/cake/pie server; gravy spoon; sauce spoon; coffee spoon; sugar spoon; steak knife; dessert fork, spoon and knife; iced teaspoon; pasta spoon; butter knife; ladles (punch, soup, and gravy); cutlery and knives; teaspoon; soup spoon; tablespoon; asparagus tongs; spaghetti tongs; salad fork; oyster/cocktail fork; ice cream spoon; and parfait spoon.

An embodiment provides for a food-contact surface of an eating utensil to be the subject of the marketing method. The food-contact surface of an eating utensil can be described in an embodiment as referring to the one or more surfaces of the eating utensil that has been designed to come into contact with an edible substance. A non-limiting example of a food- contact surface of a butter knife would be the knife blade itself, and not the handle.

An embodiment provides for advertising the eating utensil as a utensil that either from the initial physical contact of the utensil or from the resultant contact of placing the edible food substance in one's mouth via the subject utensil, doesn't altar, add, or detract to the taste of the edible substance that contacts the eating utensil.

In an embodiment, the eating utensil is advertised as preventing a user from tasting anything but the substantially pure flavor of an edible substance that is contacting or has contacted the eating utensil.

Another embodiment of the method provides for generally advertising the eating utensil as having an eating surface or food-contact surface that is made of an inert or non-reactive substance with respect to an edible substance. Additional embodiments provide for advertising the eating utensil as having an inert plastic or plastics that will not alter the flavor or taste of an edible substance that contacts or has contacted the inert plastic or plastics.

Another embodiment provides for advertising the composition of the utensil's one or more food-contact surfaces as having plastic, a non-metallic component, or an electrically nonconductive component that preserves the naturally occurring flavor of an edible substance that contacts or has contacted the utensil's one or more surfaces.

An embodiment is directed to advertising an eating utensil by describing an eating utensil that eliminates or significantly retards the cut-edge browning process normally associated with the cutting of lettuce, apples avocados, etc., with a commonplace metal knife or utensil.

Still another embodiment is directed to advertising an eating utensil by describing an eating utensil wherein the relative thermal conductivity of the subject utensil is considerably lower than that of a similarly-sized, commonplace metal utensil, which use results in heated liquids, like soups, staying at approximately the same serving temperature from soup bowl to mouth via a soup spoon or from serving bowl to individual bowls via a serving spoon.

The advertising or marketing method can occur in any media known to be used for advertising. Non-limiting examples of useful media can include television, telephones, radio, printed advertisements, and electronic media. Non-limiting examples of electronic media are web pages, websites, and advertisements that appear as pop-up advertisements on computer screens. Television advertisements can include TV commercials and infomercials. Paper-based advertisements can be directed to magazine advertisements, newspaper advertisements, and printed flyers. Additionally, advertisements within the scope of the inventive embodiments include product promotions via media news and “new gadget” media events. Advertisements can also include visual product placement in movies and other moving-picture displays. Still further, additional forms of advertisement can include coupons, posters, billboards, food-show demonstrations, door-to-door sales, and product placement for actual use in key restaurants. Non-limiting examples of printed advertisements can include magazines advertisements, newspaper advertisements, and printed flyers.

An alternate advertising or marketing method can be directed to advertising a food-contact surface of a utensil as preventing any electrical, chemical, or both electrical and chemical activity from occurring between the utensil and the user's mouth, tongue, lips, taste buds, or combinations thereof.

An alternate advertising or marketing embodiment provides for using a flavorless taste characteristic in a marketing method in combination with describing the utensil or at least one of its surfaces as being organic. Embodiments provide for understanding an organic utensil as being better for the environment from a manufacturing standpoint, healthier for the consumer, providing a better taste to an edible substance that has contacted or is in contact with the utensil via the utensil's organically inert properties relative to a commonplace metal eating utensil, or a combination thereof. Alternate embodiments provide for understanding an organic utensil as being manufactured at least partially from a soy-based polymer.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed is:

1. A method for advertising an eating utensil comprising:
advertising an eating utensil using a flavorless taste characteristic of the utensil.

2. The method of claim 1, wherein the flavorless taste characteristic is advertised as resulting from substantially preventing any additional chemical substance or electrical activity from being added to an edible substance that is in contact with or has contacted the utensil.

3. The method of claim 1, wherein the flavorless taste characteristic is advertised as preventing a user from tasting anything but the substantially pure flavor of an edible substance that is touching or has touched the eating utensil.

4. The method of claim 1, wherein the eating utensil is a fork, knife, or spoon.

5. The method of claim 1, further comprising advertising the eating utensil using the composition of the utensil's one or more surfaces.

6. The method of claim 5, wherein the composition of the utensil's one or more surfaces is advertised as having plastic, a non-metallic component, or an electrically non-conductive component.

7. The method of claim 5, wherein the one or more surfaces is advertised as a food-contact surface used to contact an edible substance.

8. The method of claim 1, wherein the advertising occurs on at least one media selected from the group consisting of printed advertisements, video, telephone, electronic, and radio.

9. The method of claim 1, further comprising advertising the utensil's one or more surfaces as being organic or at least partially organic.

10. A method for advertising an eating utensil comprising:
advertising an eating utensil by using language that generally describes a flavorless taste characteristic of the utensil in the advertisement.

11. The method of claim 10, wherein the flavorless taste characteristic is described as substantially preventing any additional chemical substance or electrical activity from being added to an edible substance that is in contact with or has contacted the utensil.

12. The method of claim 10, wherein the flavorless taste characteristic is described as preventing a user from tasting anything but the substantially pure flavor of an edible substance that is touching or has touched the eating utensil.

13. The method of claim 10, wherein the eating utensil being advertised is a fork, knife, or spoon.

14. The method of claim 10, further comprising advertising the eating utensil by describing the composition of the utensil's one or more surfaces.

15. The method of claim 14, wherein the composition of the utensil's one or more surfaces is described as having plastic, a non-metallic component, or an electrically non-conductive component.

16. The method of claim 14, wherein the one or more surfaces is described as a surface used to contact an edible substance.

17. The method of claim 10, wherein the advertising occurs in at least one media selected from the group consisting of printed advertisements, video, telephone, electronic, and radio.

18. The method of claim 9, further comprising advertising the utensil's one or more surfaces as being organic or at least partially organic.

19. A method for advertising an eating utensil comprising:
advertising an eating utensil by describing a food-contact surface of the utensil as being chemically inert when contacted with an edible substance.

20. The method of claim 19, wherein the food-contact surface of the utensil is described as being plastic or having a plastic component.

21. The method of claim 19, wherein the food-contact surface of the utensil is described as preventing electrical activity from occurring between the edible substance and the utensil.

22. The method of claim 19, wherein the advertising occurs in at least one media selected from the group consisting of printed advertisements, video, telephone, electronic, and radio.

23. A method for advertising an eating utensil comprising:
advertising an eating utensil by advertising that a food-contact surface of the utensil prevents electrical, chemical, or both electrical and chemical activity from occurring between the utensil and a user's mouth, tongue, lips, taste buds, or a combination thereof.

24. The method of claim 23, further comprising advertising the utensil's one or more surfaces as being organic or at least partially organic.
